(19) United States
(12) Patent Application Publication
(10) Pub. No.: US 2014/0379579 A1
(43) Pub. Date: Dec. 25, 2014

(54) SYSTEM AND METHOD FOR TRANSFERRING MONEY

(71) Applicant: GEORGE W. MAREALLE, Dar es salaam (TZ)

(72) Inventor: GEORGE W. MAREALLE, Dar es salaam (TZ)

(21) Appl. No.: 14/302,398

(22) Filed: Jun. 11, 2014

Related U.S. Application Data
(60) Provisional application No. 61/837,635, filed on Jun. 21, 2013.

(51) Int. Cl. G06Q 20/10

(52) U.S. Cl. CPC G06Q 20/10
USPC 705/44

(57) ABSTRACT

A system to transfer money is disclosed. The system may have a voucher having a back facing, the back facing includes a removable covered area and a plurality of instructions, the removable covered area is scratched off and a plurality of personal identification numbers are disposed underneath the removable covered area and are exposed when the removable covered area is scratched off. The system also may have a money transfer non-transitory storage medium that generates a system payment screenshot and a payment options screenshot. The system also includes a method for transferring money from a first account to a second account. The system may have one or more unique PIN numbers processes payment to transfer or deposit a predetermined money amount or to pay one or more bills or products or services.

This application claims priority to U.S. Provisional Application 61/837,635 filed on Jun. 21, 2013, the entire disclosure of which is incorporated by reference.

### BACKGROUND OF THE INVENTION

1. Field of the Invention

The present invention is a system and method for transferring money. More specifically, the present invention is a system and method for transferring money with a scratch card voucher and an Unstructured Supplementary Service Data or USSD system and non-transitory storage media.

2. Description of the Related Art

Transferring money from one account to another account securely may be a challenge. Scratch card vouchers may include information that may be a particular convenient way of providing information to securely transfer money from one account to another account.

### BRIEF SUMMARY OF THE INVENTION

The present invention is a system and method for transferring money. More specifically, the present invention is a system and method for transferring money with a scratch card voucher and an Unstructured Supplementary Service Data or USSD system and non-transitory storage media.

The present invention is a system to transfer money that includes a server system that includes an output system, an input system and a memory system which stores an operating system, a communications module, a web browser module, a web server application and a money transfer non-transitory storage medium, the money transfer non-transitory storage medium resides on the memory system and a client system that includes an output system, an input system, a memory system, a processor system, a communications system and an input and output system. The system also includes a communications network that connects the server system to the client system and the client system accesses the server system via the communications network and a voucher having a back facing, the back facing includes a removable covered area and a plurality of instructions, the removable covered area is scratched off and a plurality of personal identification numbers are disposed underneath the removable covered area and are exposed when the removable covered area is scratched off.

The present invention also includes a method for transferring money from a first account to a second account, comprising the steps of pushing poll options through a USSD menu, choosing an answer from the USSD menu, processing incoming response and calculating if a PIN number and corresponding amount has been verified and finding a valid transaction and displaying results to the client in real-time.

It is an object of the present invention to provide a system to transfer money that utilizes a scratch card voucher and Unstructured Supplementary Service Data or USSD technology.

It is an object of the present invention to provide a system to transfer money that utilizes a scratch card voucher card with a plurality of personal identification numbers or PINs that may be entered to deposit and transfer a corresponding predetermined amount of money from a first mobile payment account to a second mobile payment account.

It is an object of the present invention to provide a system to transfer money that utilizes a scratch card voucher card with a personal identification number or PIN that may be entered to directly pay for bills and other financial obligations.

It is an object of the present invention to provide a method for transferring money that utilizes a USSD non-transitory storage media to generate a plurality of cell phone with an operating system screens.

### BRIEF DESCRIPTION OF THE DRAWINGS

The present invention will be described by way of exemplary embodiments, but not limitations, illustrated in the accompanying drawings in which like references denote similar elements and in which:

FIG. 1 illustrates a system overview of a system to transfer money, in accordance with one embodiment of the present invention.

FIG. 2A illustrates a block diagram of a client system, in accordance with one embodiment of the present invention.

FIG. 2B illustrates a block diagram of a server system, in accordance with one embodiment of the present invention.

FIG. 3 illustrates an overhead view of a card voucher, in accordance with one embodiment of the present invention.

FIG. 4 illustrates a front view of a payment options screenshot, in accordance with one embodiment of the present invention.

FIG. 5 illustrates a front view of a system payment screenshot, in accordance with one embodiment of the present invention.

FIG. 6 illustrates a flowchart of a method for transferring money from a first account to a second account, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

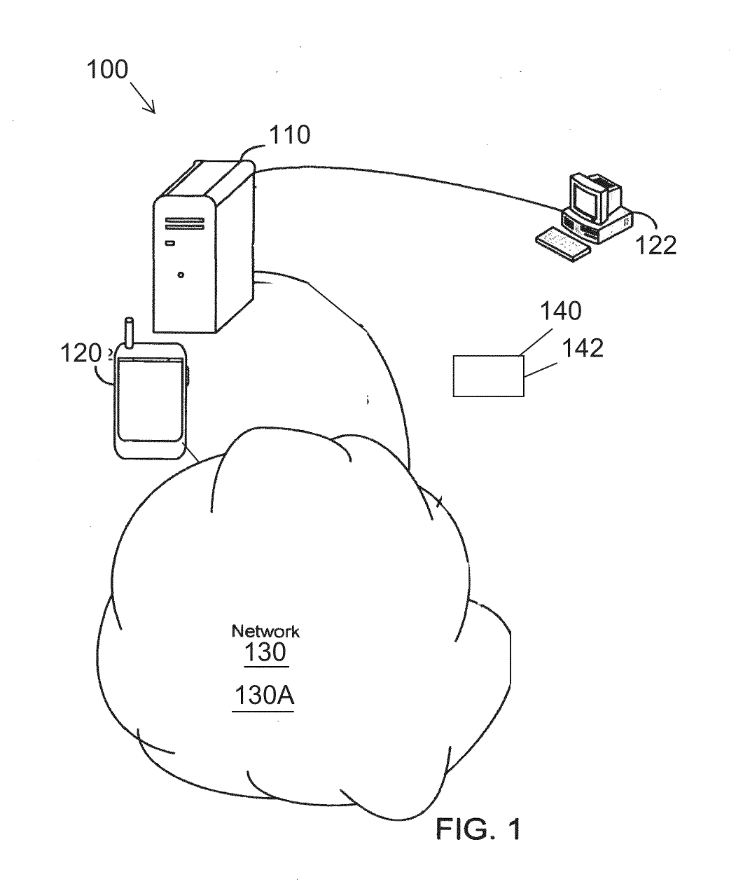

FIG. 1 illustrates a system 100 overview of a system to transfer money, in accordance with one embodiment of the present invention.

The system 100 includes a server system 110, a client system 120, a communications network 130 and a voucher 140. The server system 110 may include one or more servers. The client system 120 may be a cell phone with an operating system or SMARTPHONE®, a personal computer 122 or other suitable type of client system. The communications network 130 may be an Unstructured Supplementary Service Data or USSD network 130A, one or more local area networks or LANs, one or more wide area networks or WANs, wireless networks, telephone networks, the Internet or other suitable communications network. The server system 110 may be directly connected and/or wirelessly connected to the client system 120 and may be connected via the communications network 130. The client system 120 accesses the server system 110 via the communications network 130. The voucher 140 may be a scratch card voucher 142 or other suitable type of voucher.

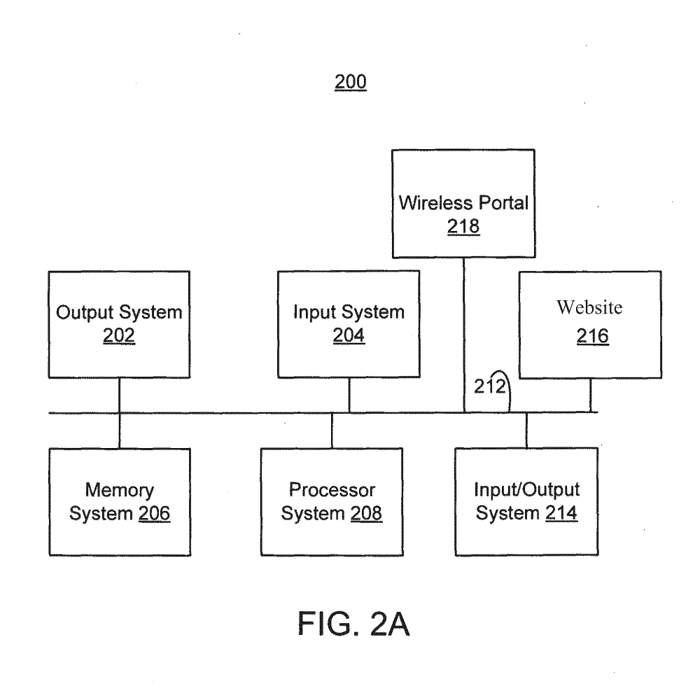

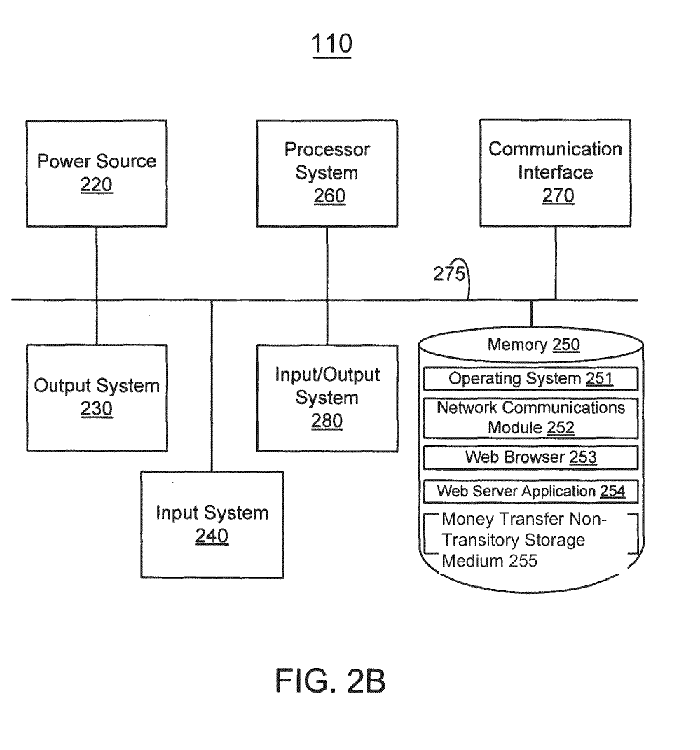

FIG. 2A illustrates a block diagram of a client system, in accordance with one embodiment of the present invention.

The client system 200 may include an output system 202, an input system 204, a memory system 206, a processor system 208, a communications system 212, an input and output system 214, a website 216 and a wireless portal 218. The client system 200 may be any one of the client systems 120,122 that may be utilized as one of the network devices of FIG. 1. The output system 202 may include a monitor system, a handheld display system, or other suitable output system. The input system 204 may include a keyboard system, a mouse system, and one or more buttons on a handheld system or other suitable input system. The memory system 206 may include a long term storage system, such as a hard drive, a short-term storage system, such as a random access memory; a removable storage system, such as a floppy drive or a removable drive, and/or a flash memory or other suitable memory system. The memory system 206 may include one or more non-transitory wave or signal mediums that may store a plurality of transfer money information. The memory system 206 specifically stores a money transfer non-transitory storage medium (FIG. 2B, 255).

The processor system 208 may include one or more processors of any suitable processor type. The processor system 208 may implement the programs stored in the memory system 206. The communications system 212 may communicatively link the output system 202, the input system 204, the memory system 206, the processor system 208, and/or the input and output system 214 to each other. The communications system 212 may include one or more electrical cables, fiber optic cables, a wireless communication system or other suitable communication system. The input and output system 214 may include devices that have a dual function as input and output devices. For example, the input and output system 214 may include one or more touch sensitive screens, which may display an image and therefore are an output device and accept input when the screens are pressed by a finger or a stylus, for example. The input and output system 214 may be optional and may be utilized in addition to or in place of the output system 202 and/or the input device 204. The client systems 120 may also be tied into a website 216 or a wireless portal 218 which may also be tied directly into the communications system 212. Any website 216 or wireless portal 218 may also include a non-transitory storage medium and a website module (not shown) to maintain, allow access to and run the website as well.

FIG. 2B illustrates a block diagram of a server system, in accordance with one embodiment of the present invention.

The server system 110 may include a power source 220, an output system 230, an input system 240, and a memory system 250, which may store an operating system 251, a communications module 252, a web browser module 253, a web server application 254 and a money transfer non-transitory storage medium 255. The server system 110 may also include a processor system 260, a communications interface 270, a communications system 275 and an input and output system 280. In other embodiments, the server system 110 may include additional components and/or may not include all of the components listed above. The output system 230 may include a monitor system, a handheld display system or any other suitable output system. The input system 240 may include a keyboard system, a mouse system, and one or more buttons on a handheld system or other suitable input system.

The memory system 250 may include a long term storage system, such as a hard drive; a short term storage system, such as a random access memory; a removable storage system, such as a floppy drive or a removable drive and/or a flash memory. The memory system 250 may include a money transfer non-transitory storage medium 255 that may store a variety of different types of information. The memory system 250 may also store the money transfer non-transitory storage medium 255. The money transfer non-transitory storage medium 255 may generate a system payment screenshot displayed on the client system output system, the system payment screenshot includes an enter voucher amount line, an enter voucher PIN number line and an OK button. The one or more unique PIN numbers may process payment to transfer or deposit a predetermined money amount or to pay one or more bills or products or services. The operating system 251 may control all non-transitory storage medium and hardware of the system 100. The communications module 252 may enable the server system 110 to communicate on the communications network 112. The web browser module 253 may allow for browsing the Internet. The web server application 254 may serve a plurality of web pages (not shown) to client systems that may request the webpages, thereby facilitating browsing on the Internet. The processor system 260 may include multiple parallel processors, a single processor, a system of processors having one or more central processors and/or one or more specialized processors dedicated to specific tasks or other suitable processors. The processor system 260 may implement the machine instructions stored in the memory system 250.

The communication interface 270 may allow the server system 110 to interface with the network 130. The output system 230 may send communications to the communication interface 270. The communications system 275 may communicatively link the output system 230, the input system 240, the memory system 250, the processor system 260 and/or the input and output system 280 to each other. The communications system 275 may include one or more electrical cables, fiber optic cables, and/or sending signals through air or water (i.e., wireless communications), or other suitable communications system. The input and output system 280 may include devices that have the dual function as the input and the output devices. For example, the input and output system 280 may include one or more touch sensitive screens, which display an image and therefore may be an output device and may accept input when the screens are pressed by a finger or a stylus, for example. The input and output system 280 may be optional and may be utilized in addition to or in place of the output system 230 and/or the input device 240.

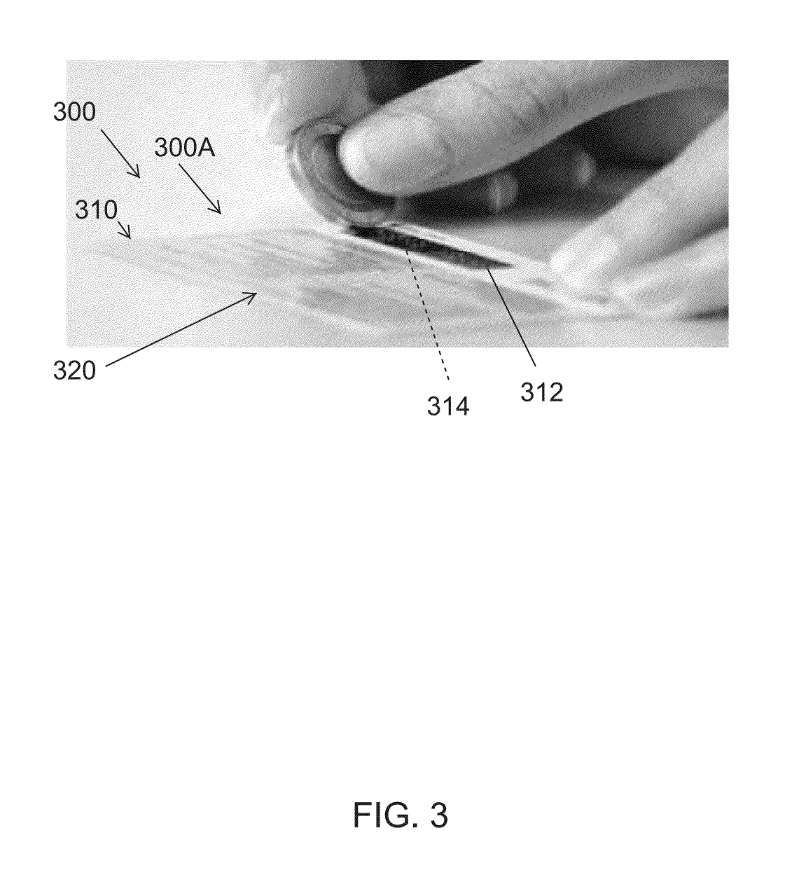

FIG. 3 illustrates an overhead view of a card voucher 300, in accordance with one embodiment of the present invention. The card voucher 300 may be a scratch card voucher 300A or other suitable type of card voucher. The scratch card voucher 300 may be made of paper or cardboard but may be made of any other suitable material such as plastic.

The card voucher 300 may include a back facing 310. The back facing 310 may include a removable covered area 312 and a plurality of instructions 320. The removable covered area 312 may be scratched off by a coin, a fingertip or other suitable object that may scratch off the removable covered area 312. FIG. 3 illustrates the removable covered area 312 being scratched off by a coin. The removable covered area 312 may be of removable material such as zinc oxide or other suitable material. A plurality of personal identification numbers or PINs 314 may be disposed underneath the removable covered area 312 and may be exposed when the removable covered area 312 is scratched off.

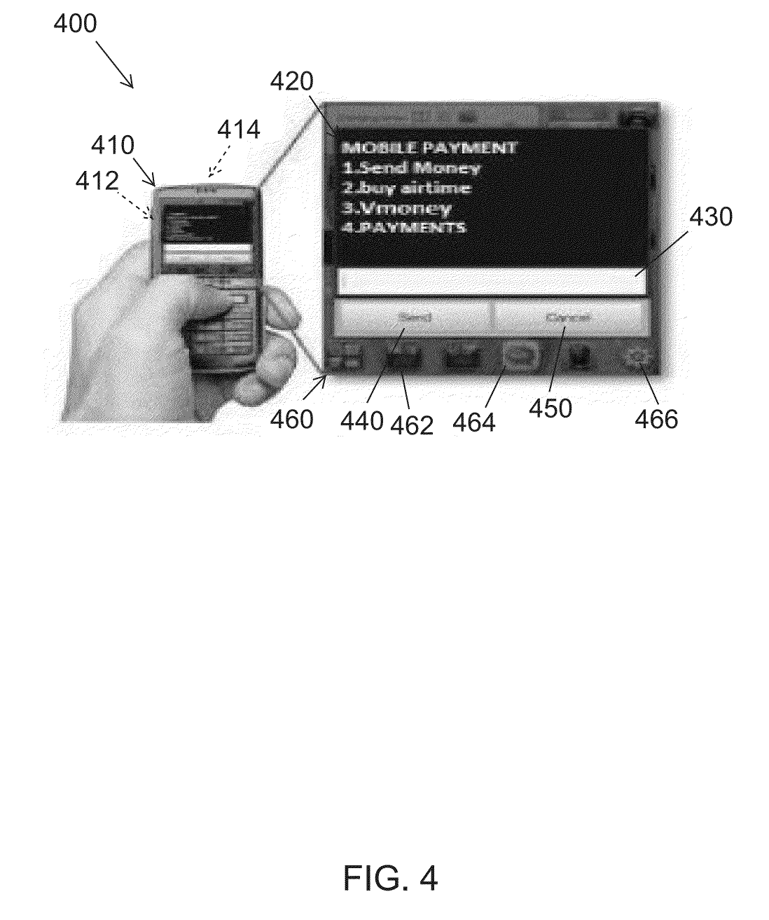

FIG. 4 illustrates a front view of a payment options screenshot 400, in accordance with one embodiment of the present invention. The payment options screenshot 400 may be displayed on the client system output system (FIG. 2A, 202).

The payment options screenshot 400 may include a client system 410, a plurality of payment options screenshot information 420, a space box 430, a send button 440, a cancel button 450 and a plurality of icons 460. The client system 410 illustrated in FIG. 4 is a SMARTPHONE® 410a but may be any suitable client system. The client system 410 may include a money transfer non-transitory storage medium 412 that generates the payment options screenshot 400. The payment options screenshot information 420 may reside on a memory system 414. The payment options screenshot information 420 may include sending money 422, buying airtime 424, a quantity of current money 426 and a history of payments 428. The space box 430 may be utilized to enter any information from the client system 410 to generate the payment options screenshot information 420. The send button 440 may be clicked on by the client system 410 to send the information from the client system 410. The cancel button 450 may be clicked on by the client system 410 to cancel the information from the client system 410. The icons 460 may include a save icon 462, a Facebook icon 464, a tools icon 464 and other suitable icons.

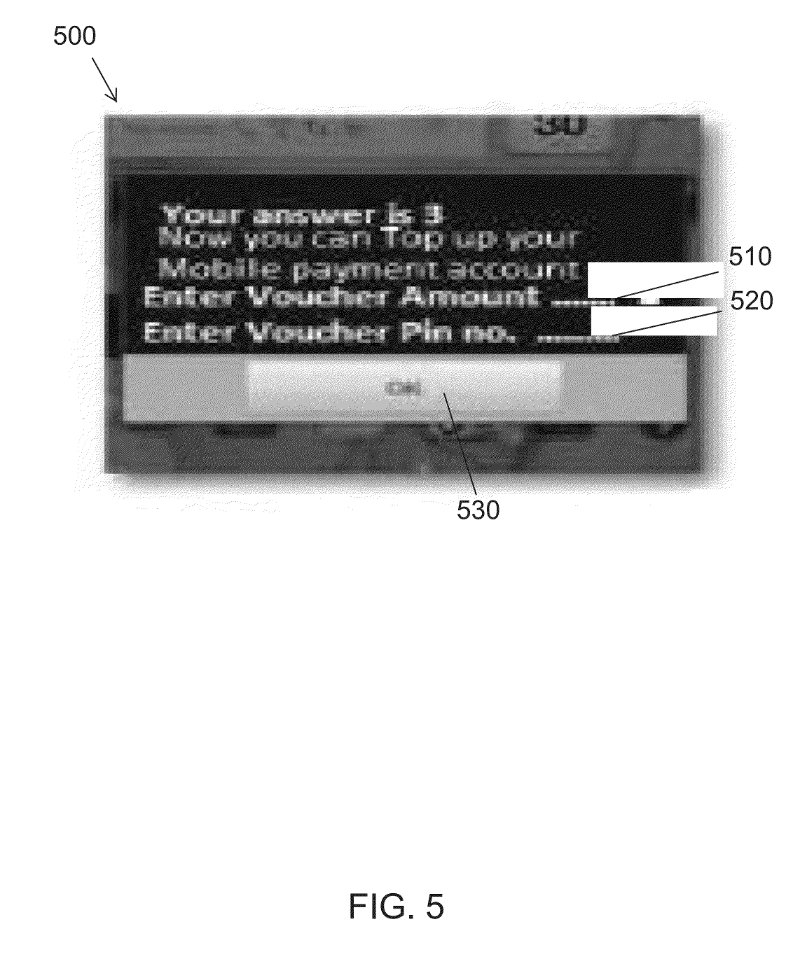

FIG. 5 illustrates a front view of a system payment screenshot 500, in accordance with one embodiment of the present invention. The system payment screenshot 500 may be displayed on the client system output system (FIG. 2A, 202).

The system payment screenshot 500 may include an enter voucher amount line 510, an enter voucher PIN number line 520 and an OK button 530. The enter voucher amount line 510 may receive an amount of voucher money that may transfer a corresponding predetermined amount of money from a first mobile payment account to a second mobile payment account. The enter voucher PIN number line 520 may be entered to deposit and transfer a corresponding predetermined amount of money from a first mobile payment account to a second mobile payment account. The OK button 530 may be clicked on by the client system (FIG. 4, 410) to confirm deposit and transfer a corresponding predetermined amount of money from a first mobile payment account to a second mobile payment account.

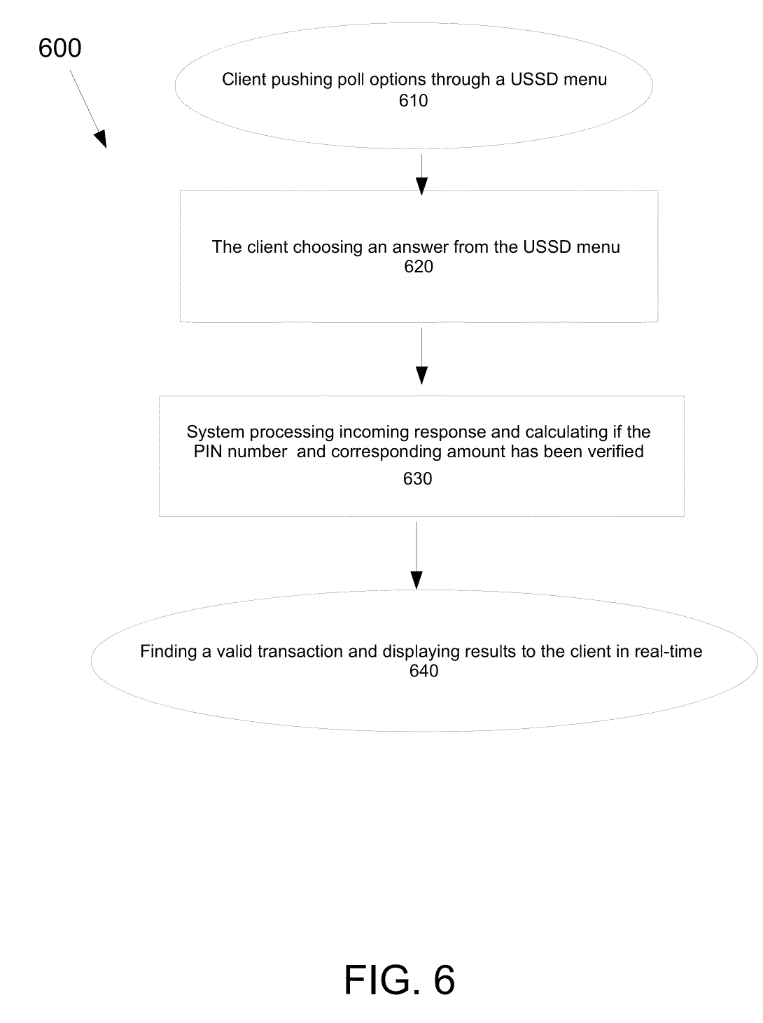

FIG. 6 illustrates a flowchart of a method 600 for transferring money from a first account to a second account, in accordance with one embodiment of the present invention.

The method 600 may include the steps of a client pushing poll options through a USSD menu 610, the client choosing an answer from the USSD menu 620, a system processing incoming response and calculating if the PIN number and corresponding amount has been verified 630 and finding a valid transaction and displaying results to the client in real-time 640.

The client pushing step 610 may include entering a monetary amount and a PIN number 612. The client choosing step 620 may include a voucher management system verifying a PIN number against a predetermined money amount 622. The client choosing step 620 may also utilize one or more applications such as an open platform application or ANDROID™, an operating system application or IOS®, an electronic equipment application or SYMBIAN™ or other suitable applications to answer from the USSD menu. The system processing incoming response step 630 may deposit the verified amount to another mobile money account holder. The finding a valid transaction step 640 may allow the PIN numbers to process a transaction via a smart phone application, a website or other suitable medium.

Utilization of the system and method for transferring money is straight-forward. Clients may purchase a scratch card voucher from one or more retail outlets such as shops, supermarkets and other suitable outlets, then scrape-off a scratchable coating in order to expose a plurality of unique PIN numbers that each correspond to a plurality of predetermined monetary quantities. The one or more unique PIN numbers processes payment to transfer or deposit a predetermined money amount or to pay one or more bills or products or services.

The system and method for transferring money is enabling to comfortably deposit money into one or more mobile payment accounts or bank holder accounts. Once money is deposited, the money may be utilized to purchase one or more different products and services or to transfer to another person or other suitable purpose. The scratch card voucher may reach a huge population and may be found in working places, supermarkets, shops and other suitable locations.

While the present invention has been related in terms of the foregoing embodiments those skilled in the art will recognize that the invention may be not limited to the embodiments described. The present invention may be practiced with modification and alteration within the spirit and scope of the appended claims. Thus, the description may be regarded as illustrative instead of restrictive on the present invention.

What is claimed is:

1. A system to transfer money, comprising:
a server system that includes an output system, an input system and a memory system which stores an operating system, a communications module, a web browser module, a web server application and a money transfer non-transitory storage medium, the money transfer non-transitory storage medium resides on the memory system;
a client system that includes an output system, an input system, a memory system, a processor system, a communications system and an input and output system, the money transfer non-transitory storage medium generates a system payment screenshot displayed on the client system output system, the system payment screenshot includes an enter voucher amount line, an enter voucher PIN number line and an OK button;
a communications network that connects the server system to the client system and the client system accesses the server system via the communications network; and
a voucher having a back facing, the back facing includes a removable covered area and a plurality of instructions, the removable covered area is scratched off and a plurality of personal identification numbers are disposed underneath the removable covered area and are exposed when the removable covered area is scratched off.

2. The system to transfer money according to claim 1, wherein the money transfer non-transitory storage medium generates a payment options screenshot displayed on the client system output system.

3. The system to transfer money according to claim 2, wherein the payment options screenshot includes a plurality of payment options screenshot information, a space box, a send button, a cancel button and a plurality of icons.

4. The system to transfer money according to claim 3, wherein the payment options screenshot information includes sending money, buying airtime, a quantity of current money and a history of payments.

5. The system to transfer money according to claim 4, wherein the icons include a save icon, a Facebook icon and a tools icon.

6. The system to transfer money according to claim 1, wherein the enter voucher PIN number line receives one or more unique PIN numbers.

7. The system to transfer money according to claim 6, wherein the one or more unique PIN numbers processes payment to transfer or deposit a predetermined money amount or to pay one or more bills or products or services.

8. The system to transfer money according to claim 7, wherein the enter voucher amount line receives an amount of voucher money that transfers the corresponding predetermined amount of money from a first mobile payment account to a second mobile payment account.

9. The system to transfer money according to claim 8, wherein the enter voucher PIN number line is entered to deposit and transfer the corresponding predetermined amount of money from the first mobile payment account to the second mobile payment account.

10. The system to transfer money according to claim 9, wherein the OK button is clicked on by the client system to confirm deposit and transfer the corresponding predetermined amount of money from the first mobile payment account to the second mobile payment account.

11. The system to transfer money according to claim 1, wherein the client system is a cell phone with an operating system.

12. The system to transfer money according to claim 1, wherein the client system is a personal computer.

13. The system to transfer money according to claim 1, wherein the communications network is an unstructured supplementary service data network.

14. The system to transfer money according to claim 1, wherein the voucher is a scratch card voucher.

15. The system to transfer money according to claim 1, wherein the scratch card voucher is made of paper or cardboard.

16. The system to transfer money according to claim 1, wherein the scratch card voucher is made of plastic.

17. A method for transferring money, comprising the steps of:
pushing poll options through a USSD menu;
choosing an answer from the USSD menu;
processing incoming response and calculating if a PIN number and corresponding amount has been verified; and
finding a valid transaction and displaying results to the client in real-time.

18. The method according to claim 17, wherein the choosing step includes a voucher management system verifying a PIN number against a predetermined money amount.

19. The method according to claim 17, wherein the processing incoming response step deposits or transfers the verified amount to another mobile money account holder.

20. The method according to claim 17, wherein the processing incoming response step pays one or more bills or products or services.
